(19) United States
(12) Patent Application Publication
(10) Pub. No.: US 2026/0194353 A1
(43) Pub. Date: Jul. 9, 2026

(54) A GYROSCOPE FIBER OPTIC COIL MANUFACTURING SYSTEM

(71) Applicant: CIVITANAVI SYSTEMS SPA, Porto Sant'EIpidio (FM) (IT)

(72) Inventors: Andrea PIZZARULLI, Porto Sant'EIpidio (FM) (IT); Alessandro SGUAZZOTTI, Porto Sant'EIpidio (FM) (IT); Paolo BELLUCO, Porto Sant'EIpidio (FM) (IT)

(21) Appl. No.: 19/128,314

(22) PCT Filed: Dec. 12, 2023
(86) PCT No.: PCT/IB2023/062525

§ 371 Date: May 8, 2025

(30) Foreign Application Priority Data
Dec. 13, 2022 (IT) 102022000025440

(51) Int. Cl. G01C 19/72; B65H 54/22; G06T 7/00

(52) U.S. Cl. CPC G01C 19/722; B65H 54/22; G06T 7/0004; B65H 2701/32; G06T 2207/20081; G06T 2207/20084

(57) ABSTRACT

System for manufacturing a fiber optic coil of a gyroscope including a mandrel with relative actuation for forward and reverse rotation, a robotic arm equipped with a first nib, in the terminal part, in which the first nib has an elongated and partially flexible shape to guide the positioning of the optical fiber during its winding on the mandrel, one more optical mechanisms arranged to continuously acquire images of the coil during the winding process, a processor operationally connected with the robotic arm, with the one or more optical mechanisms and with the actuator of the rotation of the mandrel, in which the processor is configured to control the robotic arm and to define a mechanism for controlling the actuator of the mandrel rotation as a function of the continuously acquired images, so as to control the manufacturing of the optical fiber coil.

### FIELD OF APPLICATION OF THE INVENTION

The present invention relates to the field of manufacturing optical fiber coils for gyroscopes.

### STATE OF THE ART

Fiber Optic Gyroscopes (FOGs) are sensing devices for a wide range of applications: in navigation and positioning systems, in angular velocity sensors, in stabilization equipment and in backup systems for driving autonomous vehicles in remote areas not accessible to GPS, etc.

A high-performance FOG must accurately detect phase differences between two optical signals due to rotation, minimizing or compensating phase differences due to other sources, such as temperature effects.

Existing gyro coil winding techniques require high manual skill for total precision. Attempts have been made to automate the winding of quadrupole gyro coils, but these attempts have only succeeded for very low performance coils. The technician makes corrections in case of errors, before applying the glue for each layer of the coil.

Generally, the technician works with a plastic nib with a flexible tip to guide the fiber during its winding in order to avoid overlapping. Among other things, since these are fibers with a very limited section, the technician is required to make a considerable visual effort to follow the process and intervene promptly, unwinding and rewinding the fiber in case of imperfections.

For this purpose, the technician controls the rotation motion of the mandrel, forward and reverse, on which the coil is wound.

For this reason, the technician must take breaks to rest his vision and regain the right concentration.

Because quadrupole winding is slow and painstaking work, the number of technicians capable of manufacturing high-performance coils is limited.

All this places a strong constraint on the achievable production volume which leads to high production costs of the gyroscope.

Unless specifically excluded in the detailed description that follows, what is described in this chapter is to be considered as an integral part of the detailed description. The purpose of the present invention is to automate the procedure for winding the optical fiber to form a coil suitable for installation in a gyroscope.

The basic idea of the present invention is to implement a robotic arm to which is fixed a first nib made of plastic material with a flexible tip currently in use by winding technicians. This robotic arm has the task of guiding the fiber during winding. One or more optical means are arranged to continuously acquire images of the coil during the winding process. A computer is operationally connected with the robotic arm and with the at least one optical means and with the means for controlling the rotation of the mandrel. Running on the computer is a neural network arranged to control the robotic arm and the means for controlling the rotation of the mandrel based on the continuously acquired images.

The system also comprises a training and supervisory station to accommodate a winding technician including:
at least one display, operationally connected with said one or more optical means for projecting the continuously acquired images,
a man/machine interface device comprising
   a second nib, with a haptic interface, similar to the first nib, equipped with a force and/or deformation and position sensor and
   a support system for the second nib equipped with means for acquiring the spatial position of the second nib suitable for detecting a roto-translation of the second nib imposed by the winding technician, and an interface with the second nib equipped with a load cell,
man/machine interface means for the acquisition of commands regarding the control of the mandrel rotation.

Preferably, the system also comprises a glue dispenser and glue dispenser control means operationally connected with said computer and with further man/machine interface means associated with the training station.

The dependent claims describe preferred embodiments of the invention, forming an integral part of the present description.

### BRIEF DESCRIPTION OF THE FIGURES

Further objects and advantages of the present invention will be clear from the following detailed description of an example of its embodiment (and its variants) and from the attached drawings given purely for explanatory and non-limiting purposes, in which:

FIG. 1 shows an example of a winding system according to the present invention;

FIGS. 2 and 3 show details of the system according to FIG. 1 ;

FIG. 4 shows a flow diagram representative of the circulation of information in the system shown in FIG. 1. The same reference numbers and letters in the figures identify the same elements or components or functions.

It should also be noted that the terms “first”, “second”, “third”, “higher”, “lower” and the like may be used here to distinguish various elements. These terms do not imply a spatial, sequential, or hierarchical order for the modified elements unless specifically indicated or inferred from the text.

It is worth highlighting that the use of a neural network or an inferential engine or fuzzy logic is completely equivalent.

The elements and characteristics illustrated in the various preferred embodiments, including the drawings, can be combined with each other without departing from the scope of protection of the present application as described below.

### DETAILED DESCRIPTION OF IMPLEMENTATION EXAMPLES

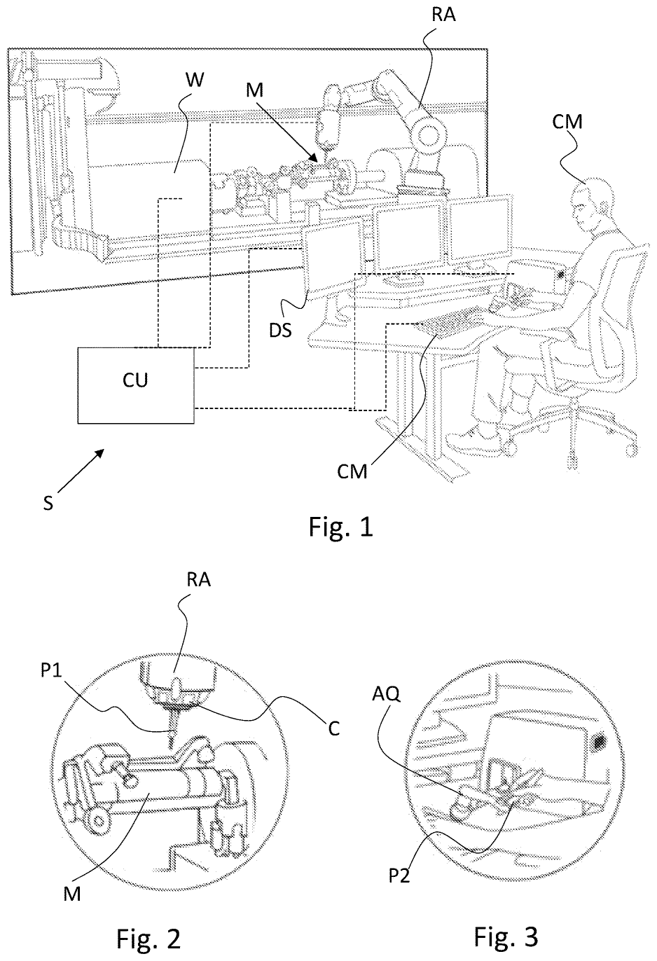

FIG. 1 shows an example of a gyroscope fiber optic coil winding system.

The system comprises
a mandrel M with relative means W for actuating the forward and reverse rotation for winding or unwinding the optical fiber coil; in general it is a winding device known in itself and controlled directly by the winding technician, when he operates directly on the coil;
a robotic arm RA equipped with a first nib P1, in the terminal part, having an elongated and partially flexible shape to guide the positioning of the optical fiber during its winding on the mandrel M; preferably, the interface between the nib and the last joint of the robotic arm includes a force sensor arranged to measure forces and torques exchanged between the first nib and the robotic arm as a reaction of the contact between the first nib and the optical fiber; alternatively the first nib is equipped with at least one strain gauge;
one or more optical means C are arranged to continuously acquire images of the coil during the winding process; preferably the optical detection means comprise a camera; it is preferably fixed to the robotic arm to adequately frame the tip of the first nib, but it can also be associated with a fixed point of the environment in which the system is placed;
A computer CU operatively connected with the robotic arm RA, with the one or more optical means C and with the actuation means 3 of the mandrel rotation. The computer runs a learning neural network arranged for
   control the robotic arm and to
   define the means for controlling the actuation means W of the mandrel rotation as a function of the continuously acquired images.

The system also comprises a supervision and training station to accommodate a TCH winding technician
at least one display DS, to project the images continuously acquired by one or more optical means C,
a man/machine interface device comprising
   a second nib P2, similar to the first nib P1, and a second nib holder AQ equipped with means for acquiring the spatial position of the second nib suitable for detecting a rototranslation of the second nib imposed by the winding technician, and in which the support is equipped with actuators to make the second nib haptic,
   man/machine interface means CM for controlling the mandrel rotation actuation means W.

The computer CU is arranged to acquire the images from the one or more optical means C and use them for the control of the robotic arm RA. At the same time, the images are shown on at least one DS display so that, if necessary, the TCH winding technician can monitor the behavior of the robotic arm.

It is worth highlighting that the present solution, even without the autonomous capabilities of the CU computer to control the manufacturing of a coil, would, however, make the posture of the winding technician more comfortable, who can be comfortably seated in his supervisory station rather than being standing near the coil.

In case of unsatisfactory behavior, the winding technician can take direct control of the actuation means W of the mandrel rotation and of the robotic arm RA using respectively
the CM man/machine interface means which can be for example a keyboard or a mouse or a joystick, e
the second nib P2.

The CU computer acquires, through the second nib holder AQ, the movements imparted to the second nib by the winding technician and controls the RA robotic arm to reproduce, in real time, the same movements.

Meanwhile, the neural network implemented in the same computer trains itself
learning that the configuration of the fiber on the coil is deemed unsatisfactory by the winding technician and
learning the movements necessary to correct this unsatisfactory configuration.

Evidently, to allow the winding technician to better train the neural network, it is advisable for the second nib to be haptic, reproducing the same resistant torques perceived by the RA robotic arm that activates the first nib.

The support system of the second nib is preferably of the pantograph type, also called DELTA and which in any case allows the operator to hold the haptic device like a normal nib and therefore without forcing the operator to use non-habitual grips. In other words, the operator must feel able to use his skills as if he were operating directly on the optical fiber, without the intermediation of the supervisory station and the robotic arm.

The robotic arm is preferably of the anthropomorphic type with six degrees of freedom, but a delta configuration with five degrees of freedom is also possible.

During the direct control of the winding operations, the neural network receives as input:
the images acquired continuously using the at least one optical device;
the position of the kinematic chain defining the robotic arm;
the magnitude of the reaction forces perceived by the first nib in the contact of the nib tip with the optical fiber;
angular position and rotation speed of the mandrel.
Coil winding state data, such as number of layers, number of turns of each layer, fiber tension, coil size, mandrel size, fiber type;

During training, in which direct control of the winding operations lies with the winding technician, the neural network also receives input, in addition to the previous information,
the spatial position of the second nib,
the commands given by the wrapping technician via the CM man/machine interface.

The neural network is preferably of the deep supervised learning type. Supervised learning allows the operator to signal to the neural network during the learning phase which are the correct movements and the correct results, in a robust way and drastically reducing the possibility of incorrect learning by leaving the reporting of errors and the system guidance during error recovery. Deep learning has among its main characteristics that of excellent image analysis capacity. An example of a dataset useful for learning is one whose characteristics include the state of the winding, for example: images or film of the fiber wound on the mandrel and related characteristics such as the mutual distance between the fibres, height of the current coil with respect to the other turns of the same layer, in order to visualize the correct or incorrect positioning of the fibres. Another aspect concerns the accelerations and/or speeds and/or positions of the mandrel, the forces and torques exerted on the nib, the commands sent by the haptic interface, when the robotic arm is controlled by the operator, with the acquisition of the positions, orientation, speed and angular accelerations of the haptic nib, quantity of glue released from the dispenser, fiber tension, section and type of optical fiber and mandrel section, coil dimensions and number of turns for each layer. All these characteristics then involve an evaluation of the quality of the winding by the operator also during the winding operations via haptic interface, usually described as “on-line” learning, for example in the case of supervised learning, which is useful for training the neural network inference engine.

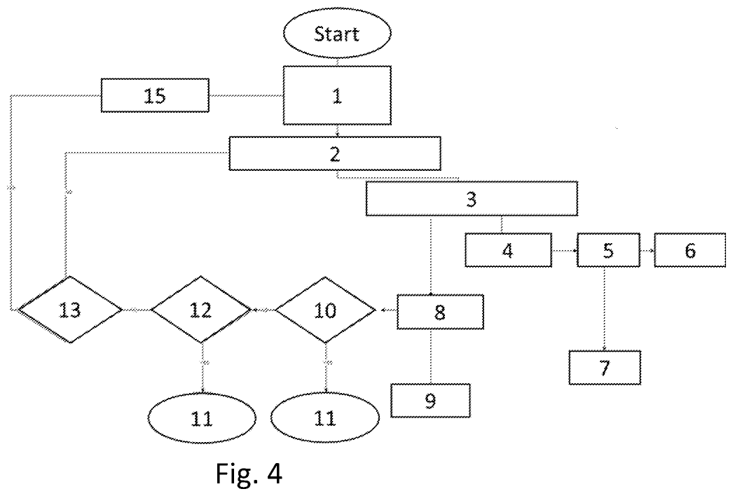

FIG. 4 shows an exemplary flow diagram of the information circulation method according to the present invention.

Having defined the system as the assembly including the mandrel M with relative actuation means W for forward and reverse rotation, the robotic arm RA equipped with the nib P1, in the terminal part, in which the first nib has an elongated and partially flexible shape for guide the positioning of the optical fiber during its winding on the mandrel M, one or more optical means C arranged to continuously acquire images of the coil during the winding process and processing means CU.

The diagram begins with the START block, as always.

Step 1: Activating the system,

Step 2: The processing means acquire information about
mandrel position,
mandrel speed,
or more sensors, such as load cells, encoders, strain gauges, etc. furthermore, the
trajectory of the nib etc.,
video stream from the camera and preferably also
quantity of glue distributed from a dispenser on the coil layer by layer;
fiber type, number of layers and number of turns in each layer,
fiber tension during winding;

Step 3: fusion of the previously acquired information, in order to create a dataset that correlates all the aforementioned information on the same timeline,

Step 4: memorization of the information processed in the previous step,

Step 5: Batch processing the fused data to enable iteratively

Step 6: Incrementally power a robotic arm control model e

Step 7: Real-time control and analysis of the winding process based on the control model generated in the previous step,

Step 8: Check whether the wrapping operation is finished, if so

Step 9: STOP, otherwise

Step 10: check if there are alarms or signals, where such alarms may be due either to quantities that do not fall within previously observed ranges, or because the control model is unable to independently control the system for any reason, if so

Step 11: STOP, otherwise go back to step 2.

It is worth highlighting that steps 1 to 6 must be performed in succession and resumed from step 1, at least once, in order to allow the system to process the information flows and generate at least a first model, which will subsequently be further updated, in the meantime, the subsequent steps 7 to 11 will be performed in real time. This is essentially a process performed in real time and a portion of the process, in particular steps 5 and 6 which are performed off-line to update the control model.

The present invention can advantageously be carried out by means of a computer program which includes coding means for carrying out one or more steps of the method, when this program is executed on a computer. It is therefore understood that the purpose of protection extends to said computer program and further to computer readable means comprising a recorded message, said computer readable means comprising program coding means for carrying out one or more steps of the method, when said program is run on a computer.

Constructive variations to the non-limiting example described are possible, without however departing from the purpose of protection of the present invention, including all equivalent embodiments for a person skilled in the art, to the contents of the claims.

From the above description, the person skilled in the art is able to implement the object of the invention without introducing further construction details.

1. A gyroscope fiber optic coil manufacturing system comprising:
a mandrel with corresponding actuation means for forward and reverse rotation;
a robotic arm equipped with a first nib in the terminal part, wherein the first nib has an elongated and partially flexible shape to guide the positioning of the optical fiber during its winding on the mandrel;
one or more optical means arranged to continuously acquire images of the coil during the winding process;
processing means operatively connected with the robotic arm with the one or more optical means and with the actuation means of the mandrel rotation;
wherein said processing means is configured for:
controlling the robotic arm; and for
controlling the actuation means of the rotation of the mandrel according to the images acquired continuously, so as to control the manufacture of the optical fiber coil.

2. The system according to claim 1, further comprising a supervisory station comprising:
at least one display for displaying the images continuously acquired by said one or more optical means;
a man/machine interface device comprising:
a second nib; and
a second nib holder system equipped with:
a haptic interface and means for acquiring the spatial position of the second nib, able to detect a roto-translation of the second nib; and
a connection interface with the second nib equipped with a load cell arranged to measure an action on the second nib;
man/machine interface means for controlling the mandrel rotation actuation means

3. System according to claim 2, wherein said supervision station is arranged to take precedence in the control of said robotic arm and of said mandrel rotation actuation means with respect to said processing means.

4. System according to claim 1, wherein said processing means are configured by means of a learning neural network.

5. System according to claim 4, wherein said neural network is arranged to enter learning mode when said supervisory station takes direct control of the robotic arm and/or of said mandrel rotation actuation means.

6. System according to claim 4, wherein said neural network is configured to be trained by means of control signals generated by said means for acquiring the spatial position of the second nib and by said man/machine interface means of said supervisory station.

7. A system according to claim 4, wherein said neural network is configured to be trained by means of a stream of images of the coil, during a winding process, generated by said optical means.
